(19) United States
(12) Patent Application Publication
(10) Pub. No.: US 2019/0103036 A1
(43) Pub. Date: Apr. 4, 2019

(54) METHOD AND SYSTEM FOR ALIGNING OCCUPATIONAL COMPETENCIES TO INSTRUCTIONAL OUTCOMES

(71) Applicant: Board of Regents of the University of Texas System, Austin, TX (US)

(72) Inventors: Edward Charles Anderson, Austin, TX (US); Duane Dale Hume, Bella Vista, AR (US); Samuel Dale Holloway, St. Peters, MO (US); Philip Michael Komarny, Colorado Springs, CO (US)

(73) Assignee: Board of Regents of the University of Texas System, Austin, TX (US)

(21) Appl. No.: 16/146,868

(22) Filed: Sep. 28, 2018

Related U.S. Application Data
(60) Provisional application No. 62/566,434, filed on Sep. 30, 2017.
(60) Provisional application No. 62/611,424, filed on Dec. 28, 2017.

(51) Int. Cl. G09B 19/00; G09B 5/00

(52) U.S. Cl. CPC G09B 19/00; G09B 5/00

(57) ABSTRACT

The present disclosure enhances the capabilities of educational institutions to refine educational offerings to evolving labor markets and employment opportunities in a dynamic way. Educational institutions are enabled to adjust the offered curriculum to maximize the effectuality of each course taken, and to enable learners to choose the most effective path towards a given educational goal. The present disclosure further enables employers to meaningfully participate in the educational process by providing feedback that can be incorporated to further improve educational outcomes.

### CROSS-REFERENCE TO RELATED APPLICATION(S)

The present application claims priority to provisional U.S. Patent Application No. 62/566,434, entitled “METHOD AND SYSTEM FOR ALIGNING OCCUPATIONAL COMPETENCIES TO INSTRUCTIONAL OUTCOMES” filed on Sep. 30, 2017 (Attorney Docket No. 747-101V1) and to co-pending provisional U.S. Patent Application No. 62/611,424, entitled “METHOD AND SYSTEM FOR ALIGNING OCCUPATIONAL COMPETENCIES TO INSTRUCTIONAL OUTCOMES” filed on Dec. 28, 2017 (Attorney Docket No. 747-101V2), the entirety of both of which is herein incorporated by reference.

### BACKGROUND

### Field of the Disclosure

The present disclosure relates generally to information handling systems and, more particularly, to information handling systems for managing and recording educational accomplishments.

### Background of the Disclosure

The present disclosure relates to information handling systems for managing and recording educational accomplishments. Education has traditionally come with a number of challenges. For example, traditional systems have made it difficult for learners to plan their careers through the pursuit of new skills relevant to employers, which may change over time, for example, due to changes in technology, society, and other influences that bear upon the job market. Learners enter educational institutions without a clear path as to how to most effectively achieve their career goals. Further, educational achievements are currently not provided at the level of detail that would be most useful for potential employers or learners. Educational outcomes are recorded in traditional forms and are limited to high level results, such as the recording of a grade for a class taken, or a course completed. Currently, instructors do not award digital certificates to learners upon a skill accomplishment at a more granular level than completion of a class. This approach lacks the detail necessary to allow the learner to pursue educational goals in the most effective manner. Current education offerings also do not take into account employer feedback of the usefulness of the curriculum, nor a measurement of the efficacy of a given educational outcome. Further missing is a technique to compare alternative educational offerings to one another. Providing a technique to compare alternative educational offerings would allow educational institutions to prioritize resources towards the most effective curriculum, which in turn would allow a given educational institution to improve its own ranking as compared to other educational institutions.

Another problem with existing techniques is the inability of learners to share their accomplishments by publishing their educational outcomes. The current method of sharing educational outcomes is limited to a transcript which provides only the list of courses and grades. This high level view of educational achievements does not fully capture the exact skillset that has been gathered by a learner through completion of the curriculum. A method is needed to provide further detail as to the skills achieved as part of the completed courses. The current inability to provide such a level of detail for the course offering also prevents new learners from choosing the most efficient path towards acquiring the desired skillset while focusing on the most effective courses to achieve that goal.

Another problem with existing techniques is the inability of third party verifiers to verify the authenticity of a learner's academic achievement. A method is needed to overcome the deficiencies of existing techniques.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a system in accordance with at least one embodiment.

FIG. 2 is a flow diagram illustrating a method for guiding a learner according to a potential effectuality index (PEI) in accordance with at least one embodiment.

FIG. 3 is a block diagram illustrating a system including a course designing subsystem in accordance with at least one embodiment.

FIG. 4 is a flow diagram illustrating a method for identifying an educational accomplishment and modifying the curriculum of the identified educational accomplishment to include a new outcome that maps to a previously unmapped occupational skills tag in accordance with at least one embodiment.

FIG. 5 is a flow diagram illustrating a method for matching occupational skills tags to an employer and providing notification in accordance with at least one embodiment.

FIG. 6 is a flow diagram illustrating a method for recording an educational accomplishment of a learner in a confirmable manner by committing an entry to immutable storage in accordance with at least one embodiment.

FIG. 7 is a flow diagram illustrating a method for selectively publishing information pertaining to an educational accomplishment of a learner in accordance with at least one embodiment.

FIG. 8 is a flow diagram illustrating a method for retrieving, verifying, and displaying an educational accomplishment of a learner in accordance with at least one embodiment.

FIG. 9 is a flow diagram illustrating a method for selectively providing an employer with an identity and educational accomplishments of a learner pertaining to occupational skills tags of interest to the employer in accordance with at least one embodiment.

FIG. 10 is a flow diagram illustrating a method for storing an educational accomplishment and an educational outcome of a learner upon cryptographic signature of an educator and a verifier in accordance with at least one embodiment.

FIG. 11 is a flow diagram illustrating a method for revoking an educational accomplishment of a learner in accordance with at least one embodiment.

FIG. 12 is a block diagram illustrating an educational supply side subsystem in accordance with at least one embodiment.

FIG. 13 is a block diagram illustrating the functional architecture of the system in accordance with at least one embodiment.

FIG. 14 is a block diagram illustrating the graph service architecture of the system in accordance with at least one embodiment.

FIG. 15 is a block diagram of an information processing system that may be used to implement a system or method or one or more elements thereof in accordance with at least one embodiment.

The use of the same reference symbols in different drawings indicates similar or identical items.

### DETAILED DESCRIPTION

### Overview

The current disclosure provides a system and method which can be used to facilitate the interaction between educational facilities, instructors, learners, verifiers, and employers. Generally, at least one embodiment of the system and method provides a capability for educational institutions to issue digital certificates for achievements attained by learners. Learners, in turn, are able to assemble the digital certificates into a portfolio which can be shared with interested parties, such as potential employers. Learners are further able to efficiently plan a path to achieve the skills required for a desired career path. This eliminates the duplication and redundancy of current educational planning. Further, at least one embodiment enables educational facilities to adjust the curriculum to the current needs of employers by comparing the effectuality index of competing classes, and adjusting a given class to increase its effectuality index to adjust for the current or projected requirements of the employment market.

The issuing educational institution includes an assessment system and an academic registry. The assessment system represents a grading system that can interface with the system to register badges and learners and to issue certificates. Instructors can access this system via a data network, for example, the Internet. An instructor evaluates and assigns a grade to a learner's work. If the grade is considered passing, then the learner is awarded a digital certificate via the system. The issuing educational institution also maintains an academic registry reflecting the academic achievements of the learners. The assessment system interacts with the academic registry to allow learners via a mobile device and internet access to authenticate, log in, and interact with the system. Learners are the students who have completed or are in the process of completing a given academic curriculum, which can occur in a variety of contexts, and have achieved digital certificates. Learners may include a variety of scenarios, such as, for example, employees receiving on-the-job training; students taking classes ranging from preschool to post-graduate school; professional school; vocational training; community education; career retraining; continuing education; professional certifications; military personnel training; and any other situation where an individual acquires new skills of interest to third parties. Similarly, educators may include any individual or institution providing such training or education. Employers may include any individual or institution interested in the new skills acquired by the learners. Learners can demonstrate achievements by emailing certificate uniform resource locators (URLs) to interested parties. Verifiers can view and validate certificates through the system. Learners can create collections of verified achievements that can be published to employers. Further, a customer relationship management system is provided to serve as the identity provider for learners and administration.

The present disclosure uses the term “badge” as a definition of an academic accomplishment award. A badge is typically composed of an image, description, and name A badge is used as a template for a digital award. The present disclosure further uses the term “digital certificate” as an instance of a badge that has been awarded to a learner. The term “digital certificate” is intended to refer to an instance of the template that is provisioned on the behalf of a learner.

At least one embodiment enables learners to organize and manage their digital certificates into collections and to allow verifiers to verify these collections so that employers can confidently rely on the learner's academic achievements. The learner can then share this verified academic achievements with persons of the learner's choosing and enable third parties to view shared achievement collections.

A solution provided by at least one embodiment addresses how the learner can make their educational path have a tangible return on investment (ROI), how the learner can adapt the learner's choices of educational offerings provided by educators to maximize the ROI of paying for higher education, and how the learner can prove and share their achievements in real time with employers and educational institutions. These goals are accomplished by enabling the learner to browse job skills and the weights of frequency of desired job skills (ratings), by enabling the learner to see the educational outcomes that relate to job skills to enable the learner to more efficiently select appropriate courses, by enabling the learner to see which badges (educational achievements/accomplishments) are awarded for selected course groupings, by enabling employers to search badges for associated outcomes that map to the skills they require, and by enabling learners to share their badges directly with potential employers at the learner's discretion in real time.

In accordance with at least one embodiment, a system and method are provided to align occupational skill and knowledge requirements and credentials to instructional pathways in education in a consistent and predictable manner. At least one embodiment comprises an academic achievement storage subsystem, a skills ledger subsystem, and a course outcomes storage subsystem.

Such elements are rendered into a consistent evaluation and reconciliation system. This system can give a learner a performance metric with which to evaluate learning paths.

The process can assess a weighted value of a particular instructional path based on vocational skills and social credibility. This can give a referential starting point for an education career.

In accordance with at least one embodiment, immutable storage, such as a blockchain, is used as a fixed data storage. The fixed storage could be any immutable record source. Thus, a system and method for aligning, writing, and distributing educational records to job skills using a block chain can be provided.

Achievements in education have traditionally been considered to be measured in courses of study completed, but such a metric has a low resolution. To provide a finer metric and convey more detailed and precise information about a learner's achievements, an extensive database of outcomes for higher education is constructed. Rather than, for example, merely noting that a learner has completed a semester of calculus, many individual outcomes may be recorded. As an example, an outcome may denote learning an exponent method of differentiation of a polynomial expression as part of what was learned during the semester of calculus.

The outcomes can be cross referenced and tagged to occupational skills tags. The occupational skills tags can denote skills an employer finds useful for an employee to have learned.

A record of a student's achievements can be verifiably established by recording a representation of the achievements or, for example, a hash value mathematically and undeniably representing the validity of the achievements, to immutable storage, for example, a blockchain. In accordance with at least one embodiment, a hybrid blockchain system can be used. The hybrid blockchain system can restrict the entity or entities able to add entries to the immutable storage. A checksum can be used to assure that an entry is added to the immutable storage. Assurance of addition of an entry to immutable storage provides guaranteed delivery. Guaranteed delivery can be used to assure that an educational accomplishment will be verifiable using the entry added to the immutable storage.

Practical utility of educational achievements can be characterized by mapping end-to-end data associations from industry to learning to educational lifetime records.

As an example, educational accomplishments, educational outcomes, and occupational skills tags can be matched and correlated into a useable product for the learner to use for evaluating the utility of proposed courses of study to be undertaken.

The matching and correlating can be, for example, based on weighted matching of skills tags, with respect to the outcomes database which is aligned with blockchain records (badges).

As an example, relationships in the data model can exist mapping many items to an even greater number of items, meaning that each component can be associated to multiple components of another domain. The higher the number of associations of each component to another is a higher weight, which would indicate a “best” choice vector for a user. The lower the number of associations to each component would also lead to a “best” choice vector for a user in that the weight could indicate a specialization learning path. The larger raw data sources provide a more accurate sample for weighting, thus creating a more visible career vector for the learner.

Weighted algorithmic matching can be used to match data elements, such as a matching occupational skills tags of interest to an employer, to a course of study, an educational accomplishment of a learner, or an educational outcome.

### Potential Effectuality Index

In accordance with at least one embodiment, a potential effectuality index (PEI) can be used to provide weighted algorithmic matching. As one example, a PEI can be calculated as PEI=ScF(S/O)², where Sc represents an average social credibility rating of a badge, S represents a number skills associated to the badge, O represents the number of outcomes related to the skills associated to the badge, and F represents the number of discrete “favorites” associated to the badge. The badge can be a badge of achievement representing, for example, an educational accomplishment. The average social credibility rating can be obtained by averaging rating values of the badge provided by persons qualified to rate the badge, such as learners who have earned the badge. The average social credibility rating can be confined to a finite range, for example, a maximum value of five or another number. The value within the finite range can serve as a coefficient used in the calculation of the PEI. The skills associated with the badge can be represented by occupational skills tags. The outcomes related to the skills associated to the badge can be granular (e.g., atomic) identifiable outcomes learned in obtaining the skills associated to the badge. The “favorites” can be a number of unique instances of picking favorite badges as identified by employers on a per-employer basis. The number of outcomes can be defined to be greater than the number of skills, which can serve to keep the squared term of the equation less than one.

The PEI can be used as a guide to learners in their application of their efforts toward furthering their studies. The ability to record to an academic record issuance database a first certificate representing a first educational accomplishment of a learner, to record a first set of educational outcomes attained pertaining to the first educational accomplishment, to commit to an academic record issuance immutable store an issuance verification value dependent on the first certificate, to record a first set of occupational skills tags pertaining to the first set of educational outcomes; for a second badge representing a second educational accomplishment not yet attained by the learner, to determine a potential effectuality index (PEI) value based on a second set of educational outcomes pertaining to the second educational accomplishment and on a second set of occupational skills tags pertaining to the second set of educational outcomes, and to generate a guidance plan for the learner based on the PEI provides a technological improvement over previous technology, as it synergistically combines the first certificate, the educational outcomes, the occupational skills tags, while immutably storing the issuance verification value, and, through the determination of the PEI, provides generation of the guidance plan for the learner. Such a synthesis of diverse elements for the potential benefit of a variety of interests, such as guidance of the learner, recordation of certificates representing educational accomplishments, and recordation of occupational skills tags valuable for the learner to seek employment has not been previously achieved yet is provided as disclosed herein.

### Opportunity Engine Technology

Learners, educators, and employers are stakeholders in an educational process. Learners gain an education from educators, which makes the learners more valuable to employers, allowing learners to gain employment and earn a living. Educators help learners gain an education and help transform learners into job candidates desirable to employers. Employers hire learners to make them employees and pay them, which motivates learners and educators to continue learning and educating, respectively.

However, the variety of jobs available, the length of time involved in obtaining an education, and the naivety of learners prior to obtaining an education, as well as changes in technology and society over the time span during which an education is obtained, can complicate and distort a learner's perspective on decisions so important to a learner's career and entire life. At least one embodiment of a system and method provides timely communication and quantification of relevant information upon which stakeholders can act, improving the education process.

According to at least one embodiment, the system provides a learner interface for a learner to browse job skills and weights of frequency (ratings). The system informs the learner of educational outcomes that map to job skills and guides the learner to more efficiently select appropriate courses to study. The system informs the learner of which badges are awarded for selected course groupings. The system provides an employer interface enabling employers to search badges for associated outcomes that map to the skills they require. The system provides, through the learner interface, the ability for learners to selectively share one or more badges with one or more employers at the learners' discretion at any time. The system provides, through the use of immutable storage, the ability for employers and others to verify the one or more badges the learners are selectively sharing. The selective sharing can include, for example, the granting of permission by the learner to the employer or other entity to view and validate the one or more badges.

The system can perform a cost-benefit analysis on the costs (e.g., time, money, effort, etc.) of obtaining an education along an educational path and the benefit to be derived from having obtained such an education. The costs can be determined based on a tuition cost (e.g., cost per unit times units per badge times badges needed to satisfy skills tags need to be hired to perform a job). The benefit can be determined based on the pay for the job. The value for the pay for the job can be adjusted, for example, based on the time value of money over the time during which the education is being obtained, based on a number of years an employee may be expected to work at the job, based on other factors, or based on combinations thereof. The system can analyze the costs and benefits and guide the learner as to how the learner may maximize the learner's return on investment (ROI), for example, by using technology to efficiently achieve educational outcomes satisfying the desired skills tags needed to obtain a well-paying job. The system can provide a mechanism for a learner to prove and share their achievements in real time with employers and educational institutions.

The system can comprise a repository of digital skills tags, a digital ledger of educational outcomes, and immutable storage. The immutable storage can be implemented, for example, as a blockchain. The blockchain may be fully distributed and entirely public, such as a cryptocurrency, for example, Bitcoin. Alternatively, the blockchain may be partially or fully centralized. The blockchain may be partially or fully private, instead of being fully public. While a fully distributed and entirely public blockchain works well for a cryptocurrency, where a centralized actor could be tempted to steal wealth of those who rely on the centralized actor, there is no similar temptation for an educator to steal educational achievements from a learner, as the educator is already renown for possessing a level of pertinent knowledge greater than or at least equal to the educational achievements the learner is obtaining. Thus, concerns pertinent to educational records, such as privacy concerns, may motivate use of an at least partially centralized and at least partially private blockchain subsystem to implement immutable storage 106.

Application programming interfaces (APIs) and web services can be used to provide interfaces for learners, educators, employers, publishing venues, combinations thereof, and the like. The system can use a weighted matching method to enable meaningful comparisons among educational outcomes, educational achievements, and skills tags. Sorting and matching using such a method can tie immutable educational achievements to current educational requirements to current industry skills.

### DETAILED DESCRIPTION OF THE DRAWINGS

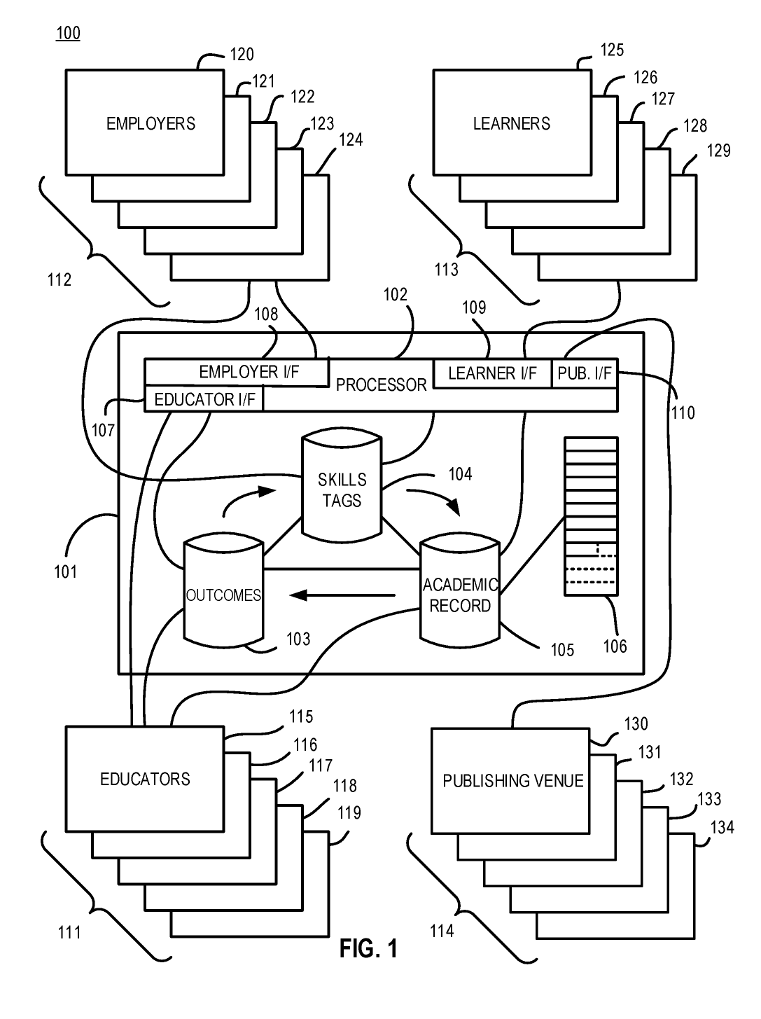

FIG. 1 is a block diagram illustrating a system in accordance with at least one embodiment. System environment 100 comprises system 101, educator client processing systems (“educators”) 111, employer client processing systems (“employers”) 112, learner client processing systems (“learners”) 113, and publishing venue client processing systems (“publishing venues”) 114. Educator client processing systems 111 comprise a plurality of individual educator client processing systems 115, 116, 117, 118, and 119. Employer client processing systems 112 comprise a plurality of individual employer client processing systems 120, 121, 122, 123, and 124. Learner client processing systems 113 comprise a plurality of individual learner client processing systems 125, 126, 127, 128, and 129. Publishing venue client processing systems 114 comprise a plurality of publishing venue client processing systems 130, 131, 132, 133, and 134. The illustrated numbers of educator client processing systems 111, employer client processing systems 112, learner client processing systems 113, and publishing venue client processing systems 114 are exemplary, and embodiments may be practiced with varying numbers of educator client processing systems 111, employer client processing systems 112, learner client processing systems 113, and publishing venue client processing systems 114. Such varying numbers may include a single one of at least one of the entities as an alternative to a plurality.

System 101 comprises processor 102, outcomes storage 103, skills tags storage 104, academic record storage 105, and immutable storage 106. As an example, a subsystem comprising a subset of the above components can be implemented at one location, with at least one component, such as immutable storage 106, implemented at another location or distributed among multiple locations. Alternatively, all of the components can be implemented at the same location.

Processor 102 comprises educator interface 107, employer interface 108, learner interface 109, and publishing venue interface 110. Educator interface 107 is coupled to educator client processing systems 111. Employer interface 108 is coupled to employer client processing systems 112. Learner interface 109 is coupled to learner client processing systems 113. Publishing venue interface 110 is coupled to publishing venue client processing systems 114.

Processor 102 is coupled to outcomes storage 103, to skills tags storage 104, and to academic record storage 105. Academic record storage 105 is coupled to immutable storage 106. Educator client processing systems 111 are coupled to outcomes storage 103 and to academic record storage 105. Employer client processing systems 112 are coupled to skills tags storage 104. Outcomes storage 103 is coupled to skills tags storage 104. Skills tags storage 104 is coupled to academic record storage 105. Academic record storage 105 is coupled to outcomes storage 103.

Employers can use employer client processing systems 112 to log into the system 101 via employer interface 108 and provide job skill tags to be stored in skills tags storage 104. These skills tags relate to job skills sought by the employers and relevant to career opportunities available at the employers. Learners can use learner client processing systems 113 to log into the system via learner interface 109. Learners can review skills tags, and register and publish academic outcomes. Publishing interface 110 allows learners to publish achievements for viewing and for authentication by potential employers. Educators can use educator client processing systems 111 to log into the system via educator interface 107 and to provide educational outcomes to be stored in outcomes storage 103. Educational accomplishments (badges) are stored in academic record storage 105. An ability to verify the educational accomplishments stored in academic record storage 105 can be provided by storing information, such as a value dependent upon the representation of the educational accomplishments stored in academic record storage 105, in immutable storage 106. Immutable storage 106 may be implemented in suitable immutable database structure, for example, a block chain database structure. Publishing venues can use publishing venue client systems 114 to interact with system 101 via publishing interface 110 and to enable learners to publish achievements.

Employers can use employer client processing systems 112 for creation and cataloging of skills tags data, which can be stored in skills tags storage 104. Educators can use educator client processing systems 111 for outcome generation and aggregation of educational outcomes, which can be stored in outcomes storage 103. Educators can use educator client processing systems 111 for issuing educational accomplishments, such as certificates, degrees, or other types of badges, which can be stored in academic record storage 105. Verification of the educational accomplishments stored in academic record storage 105 can be performed using a verification value, such as a cryptographic hash function output, or “hash,” of the educational accomplishments. The verification value can be stored in immutable storage 106 to prevent tampering with the verification value. Since the verification value is specific to the content of the educational accomplishments, the tamper prevention provided by immutable storage 106 is extended, by use of the verification value, to provide tamper prevention for academic record storage 105.

Educators can use educator client processing systems 111 for generating and aggregating educational outcomes, which can be stored in outcomes storage 103. Learners can used learner client processing systems 113 to interact with system 101, including processor 102 of system 101, to obtain a processed and aligned learner journey path.

A system for recording educational accomplishments and for managing records pertaining thereto provides technological improvement over previous technology. Such a system comprising an educational outcomes database configured to store educational outcomes achieved by learners, an academic record database configured to store certificates earned by learners, an occupational skills tags database configured to store occupational skills tags, an academic record immutable store configured to store a verification value dependent on at least a first one of the certificates, and a processor, the processor coupled to the educational outcomes database, to the academic record database, and to the occupational skills tags database, the processor comprising a learner node interface, an educator node interface, and an employer node interface, the processor configured to interface to at least one learner node via the learner node interface, to at least one educator node via the educator node interface, and to at least one employer node via the employer node interface, the processor further configured to process requests to access the educational outcomes database, the academic record database, and the occupational skills tags database, synergistically combines the first certificate, the educational outcomes, the occupational skills tags, while immutably storing the issuance verification value, and, through the determination of the PEI, provides generation of the guidance plan for the learner. Such a synthesis of diverse elements for the potential benefit of a variety of interests, such as guidance of the learner, recordation of certificates representing educational accomplishments, and recordation of occupational skills tags valuable for the learner to seek employment has not been previously achieved yet is provided as disclosed herein.

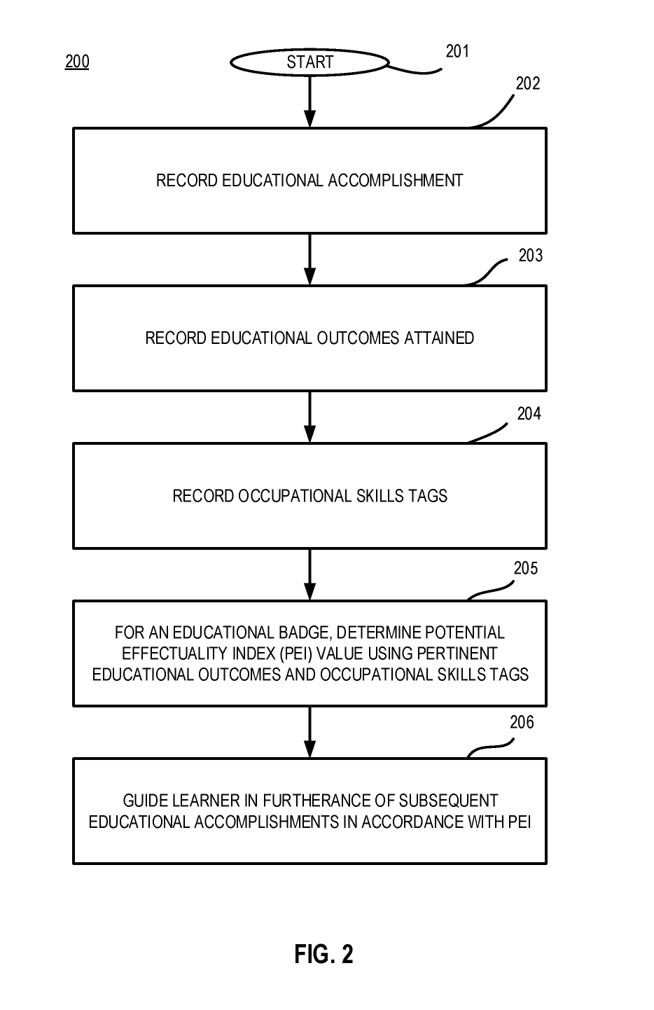

FIG. 2 is a flow diagram illustrating a method for guiding a learner according to a potential effectuality index (PEI) in accordance with at least one embodiment. Method 200 begins in block 201. From block 201, method 200 continues to block 202. In block 202, an educational institution can either directly record an educational accomplishment or submit the same to a formal entity for recording. For example, a community college could forward an educational accomplishment to a university for recording. Each educational accomplishment can comprise multiple educational outcomes. For example, finishing a calculus class may involve multiple educational outcomes that correspond to the lessons mastered by the learner as part of completing that class. From block 202, method 200 continues to block 203. In block 203, the educational outcomes are recorded that correspond to the educational accomplishment of block 202. From block 203, method 200 continues to block 204. The system determines the related occupational skills tags, and records the same in block 204. The related occupational skills tags originate from the skills that are desired by the employers registered in the system. Employers create list of skills that are desired by the employer. The system then identifies which skills are implicated by the outcomes recorded in block 203 that are part of the achievement recorded in block 202.

From block 204, method 200 continues to block 205. In block 205, the potential effectuality index (PEI) value is determined using pertinent educational outcomes and occupational skills. This calculation is performed for each educational badge, i.e., each educational achievement. The potential effectuality index (PEI) can be calculated according to the potential effectuality index described in more detail in the corresponding section titled “potential effectuality index.” The PEI can then be used to allow schools to evaluate the effectiveness of an educational badge (such as a completed class) in order to improve class offerings. For example, if a class scores a low PEI, it may be altered in order to increase its PEI rating, or it may be replaced with a class with a higher PEI rating. The PEI rating reflects the effectiveness of the skills taught by that class as related to the demand for these skills in the current job market. The PEI also takes into account evaluations of the class by both employers and learners, as described in more detail in the corresponding section. PEI ratings can also be used to allow learners to more efficiently take classes (complete educational achievements) in order to maximize relevant skills needed for a chosen profession. From block 205, method 200 continues to block 206. In block 206, the system guides the learner in furtherance of subsequent educational accomplishments in accordance with their PEI. This enables the learner to most effectively reach the skill level required for a desired career offered by employers.

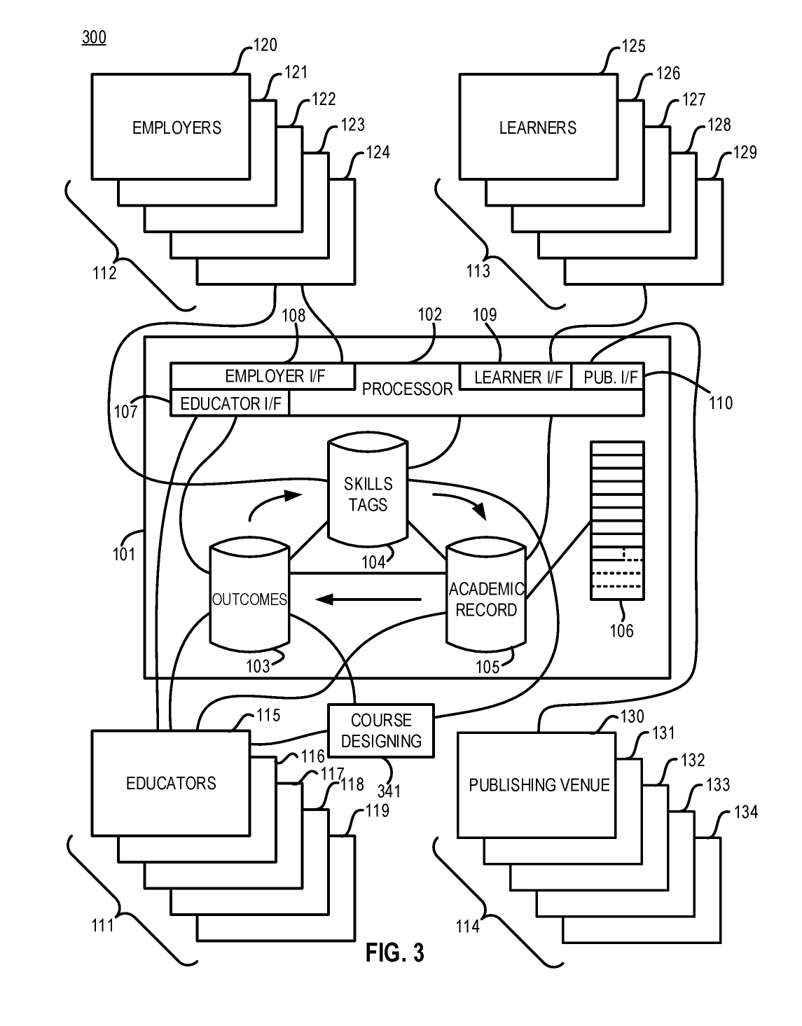

FIG. 3 is a block diagram illustrating a system including a course designing subsystem in accordance with at least one embodiment. FIG. 3 depicts the system of FIG. 1 with the addition of a course designing subsystem 341 which allows the educational facility to take the PEI into account in order to better design the educational offering for students to achieve desired skillsets in the most efficient way. System environment 300 comprises course designing subsystem 341 in addition to the elements of system environment 100 of FIG. 1. Course designing subsystem 341 is coupled to outcomes storage 103, to skills tags storage 104, and to educator client processing system 111. Optionally or alternatively, course designing subsystem 341 may be coupled to processor 102. The course design subsystem 341 allows the educational facility to compare its classes with each other to determine which is more effective for future employment. It further allows the educational facility to accommodate the needs of the industry in the class offering—by taking into account the skills/outcomes ratio and the employer feedback corresponding to given classes.

Employers can provide skills tags of interest to the employers via employer client processing systems 112. Such skills tags can pertain to jobs which the employers would like to hire personnel to perform. Such skills tags can be stored in skills tags storage 104. Educators can provide, via educator client processing systems 111, educational outcomes resulting from the educational courses they offer, which can be stored in outcomes storage 103. Course designing subsystem 341 can compare the skills tags stored in skills tags storage 104 to the outcomes stored in outcomes storage 103. Where skills tags exist in skills tags storage 104 for which no corresponding outcomes exist in outcomes storage 103, course designing subsystem 341 can identify an educational course offered by the educators in which the outcomes not currently provided could be provided in context with an existing curriculum of the educational course. Such identification can be made by comparing outcomes currently provided by educational courses to the outcomes not currently provided to identify those outcomes among the outcomes of the currently provided outcomes which are generally similar to the outcomes not provided. Course designing subsystem 341 can communicate with educator client processing systems 111 to inform educators of changes that may be made to the identified educational courses offering the generally similar outcomes so that such identified educational courses may further include in their curricula an offering of the outcomes not currently provided.

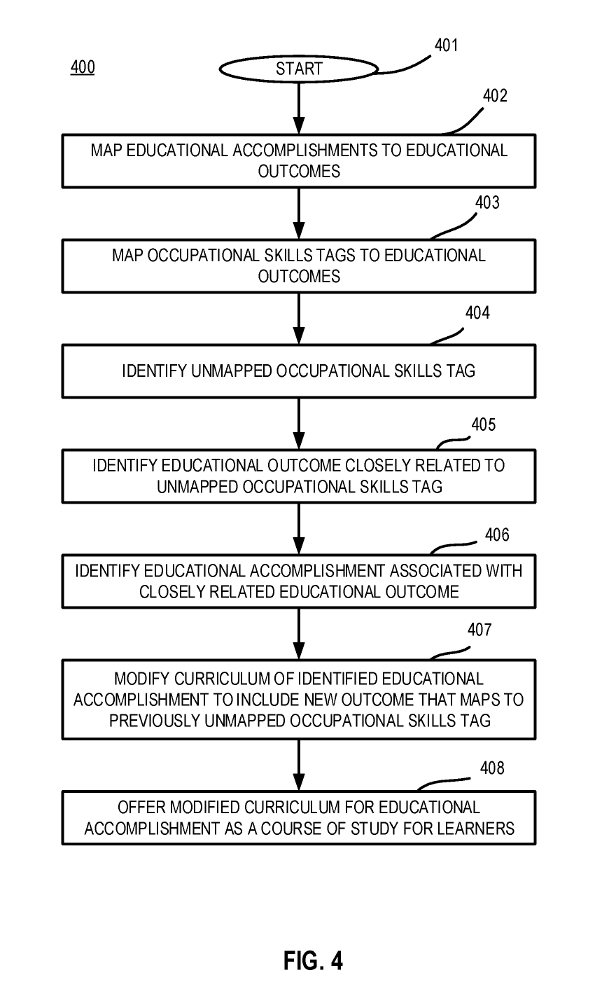

FIG. 4 is a flow diagram illustrating a method for identifying an educational accomplishment and modifying the curriculum of the identified educational accomplishment to include a new outcome that maps to a previously unmapped occupational skills tag in accordance with at least one embodiment. Method 400 begins at block 401. From block 401, method 400 continues to block 402. In block 402, the system maps educational accomplishments to educational outcomes. This step identifies all educational outcomes that are associated with a given educational achievement. This is a many-to-many relationship, as a single educational achievement will comprise many educational outcomes, and since multiple educational achievements may comprise the same educational outcome. From block 402, method 400 continues to block 403. In block 403, the system maps skill tags to educational outcomes. This mapping reflects the relationship between the educational outcomes achieved by the learner and the skill tags entered by the employer that reflects the current job market. From block 403, method 400 continues to block 404. In block 404 then, the system identifies any remaining unmapped occupational skills tags. If such unmapped occupational skills tags are known, that indicates that the current educational curriculum should be altered to provide educational achievements that include educational outcomes that relate to these skills tags. This information enables the system to dynamically update the educational curriculum to adapt to the skills tags most relevant to the current job market, and to add new skills tags that were not previously available to the learners. The system thereby identifies skills that are not taught in any classes, thereby enabling the educational institution to update its class curriculum to meet the unmet need of the employers.

From block 404, method 400 continues to block 405. The goal of updating the class curriculum to incorporate the unmet skills tags can be accomplished by identifying closely related educational outcomes that might easily be modified to incorporate educational outcomes that would meet the previously unmet skills tags in block 405. From block 405, method 400 continues to block 406. Classes comprising such closely related educational outcomes are the most likely candidates to be modified to meet the additional skill needed. The system thereby identifies the most closely related class (educational achievement) that can be modified to add the educational outcome related to the previously unmet skill in block 406. From block 406, method 400 continues to block 407. The system is thereby able to dynamically modify the educational offering to accommodate previously unmet skills tags in block 407 and thereby enable learners to more effectively attain desired educational goals towards a desired career. Alternatively, the system enables the educational institution to simply offer new classes to now include the unmapped skills in block 407. From block 407, method 400 continues to block 408. The updated curriculum is then offered to the learners in block 408.

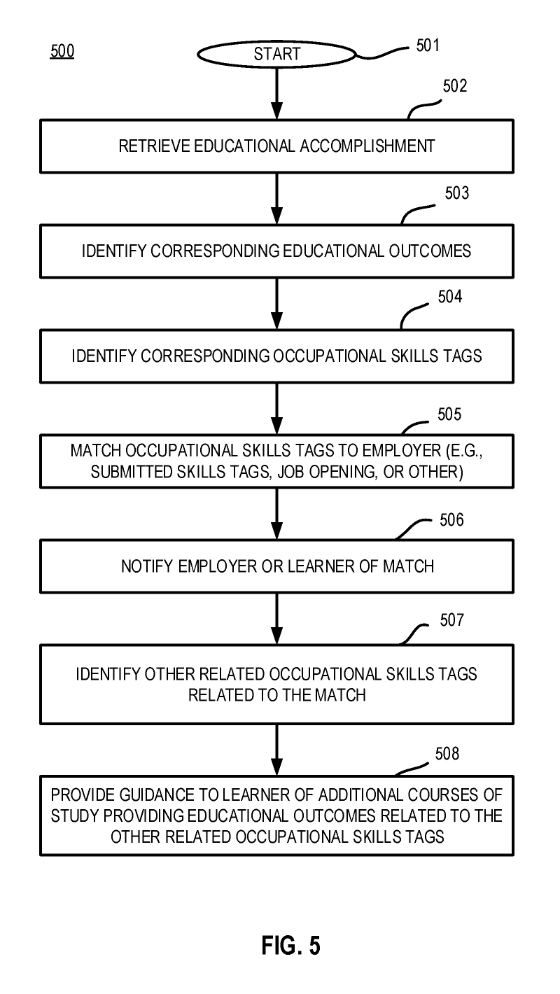

FIG. 5 is a flow diagram illustrating a method for matching occupational skills tags to an employer and providing notification in accordance with at least one embodiment. FIG. 5 illustrates an aspect of the system in which occupational skills tags corresponding to an educational accomplishment (or its corresponding educational outcomes) are matched to an employer, for example, based on an employer's submitted skills tags, an employer's job opening, or other criteria provided by the employer. Either or both of the employer and the learner are notified of a match. Method 500 begins in block 501 and continues to block 502. In block 502, a learner's (or job applicant's) academic achievements are retrieved. Method 500 continues from block 502 to block 503. In block 503, for each of the learner's academic achievements, the corresponding educational outcomes are identified. Method 500 continues from block 503 to block 504. In block 504, for each corresponding educational outcome, the corresponding occupational skills tags submitted by the employers are identified. In this way, the educational outcomes of the learner's educational achievements are “translated” to job related skills tags that are actually desired by the employers. From block 504, method 500 continues to block 505. In block 505, occupational skills are matched to an employer. For example, the occupational skills tags can be matched to submitted skills tags, a job opening, or other information provided by the employer via an employer client processing system. From block 505, method 500 continues to block 506. When a match is found, i.e., a learner matches all of or a minimal number of desired skills tags, the employer, the learner, or a combination thereof are notified of the match in step 506. This enables learner, the employer, or both, to identify potential job matches. From block 506, method 500 continues to block 507. In block 507, the system then identifies other related occupational skills tags related to the match. This enables the system to suggest the other related occupational skills tags to the learner in order to further increase the learner's skillset towards the desired career. From block 507, method 500 continues to block 508. In step 508 then, the system provides guidance to the learner of additional recommended courses providing the educational outcomes related to the relevant occupational skills tags. Accordingly, a learner may tailor the learner's studies to improve the learner's value to the employer.

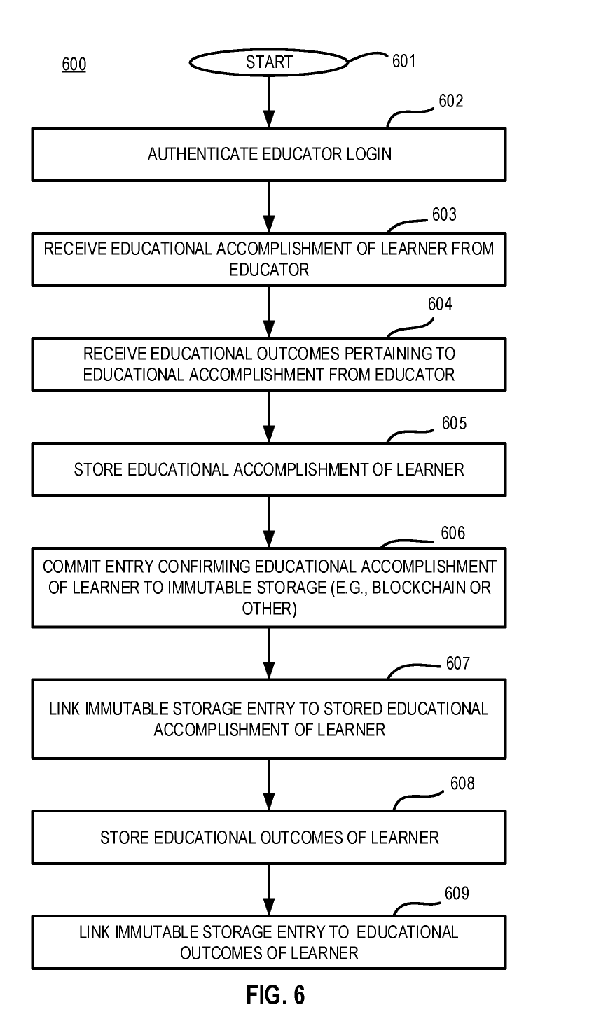

FIG. 6 is a flow diagram illustrating a method for recording an educational accomplishment of a learner in a confirmable manner by committing an entry to immutable storage in accordance with at least one embodiment. Method 600 begins in block 601 and continues to block 602. In block 602, the educator logs in to the system and is authenticated. From block 602, method 600 continues to block 603. In block 603, the system receives an educational accomplishment of the learner from the educator. From block 603, method 600 continues to block 604. In block 604, the system receives the corresponding educational outcomes pertaining to the educational accomplishment of the learner from the educator. From block 604, method 600 continues to block 605. The educational accomplishment of the learner is then stored in the database in block 605. From block 605, method 600 continues to block 606. An entry confirming the educational accomplishment of the learner is committed to the immutable storage (i.e. a blockchain) in block 606. From block 606, method 600 continues to block 607. The system then links the new immutable storage entry to the stored accomplishment of the learner in block 607. From block 607, method 600 continues to block 608. In block 608, the system then stores the updated educational outcomes of the learner. From block 608, method 600 continues to block 609. In block 609, the system links the immutable storage entry to the stored educational outcomes of the learner.

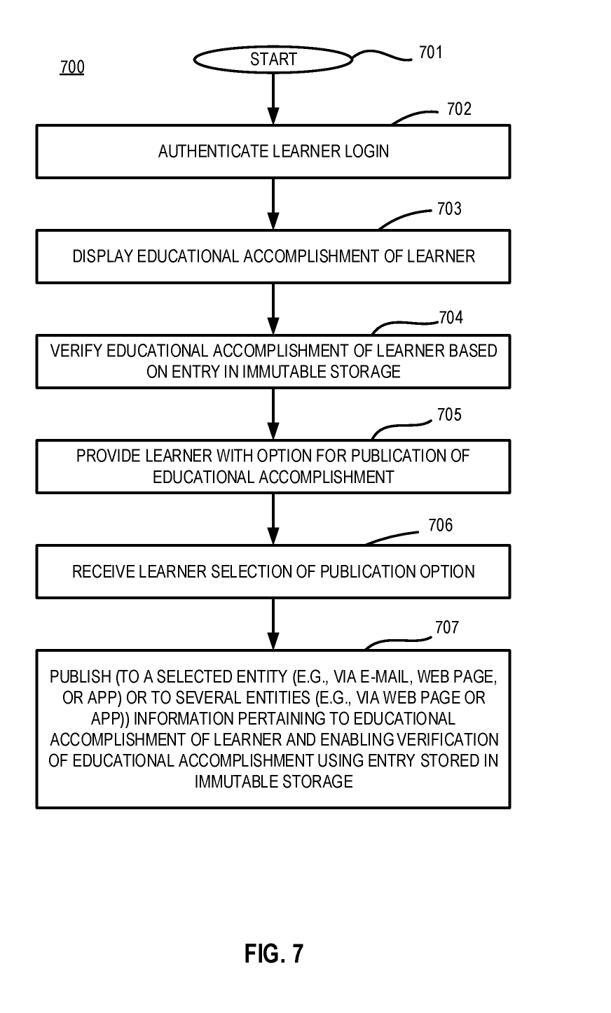

FIG. 7 is a flow diagram illustrating a method for selectively publishing information pertaining to an educational accomplishment of a learner in accordance with at least one embodiment. Method 700 begins in block 701 and continues to block 702. The learner logs into the system in block 702. Method 700 continues from block 702 to block 703. The system then displays the educational accomplishments of the learner in block 703. From block 703, method 700 continues to block 704. The system verifies (based on an entry in immutable storage) an educational accomplishment of the learner in block 704. From block 704, method 700 continues to block 705. In block 705, the system provides the learner with an option to publish the educational accomplishment. Method 700 continues from block 705 to block 706. The system receives the learner's selection of a publication option in block 706. Method 700 continues from block 706 to block 707. Upon receipt of the learner's selection of that option in block 706, the system publishes information pertaining to the educational accomplishment in block 707. The information may be a uniform resource locator (URL), optically recognizable code (e.g., bar code), or some other form of identification. The information may be published via electronic mail (e-mail), via a web page, via a software application (i.e., an “app”), or via some other mode of displaying the information to a desired audience.

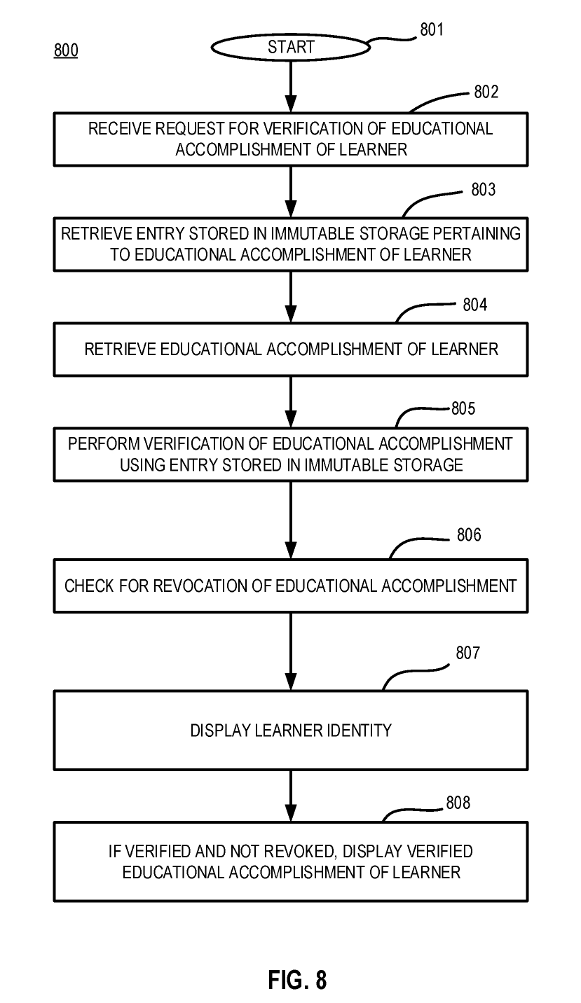

FIG. 8 is a flow diagram illustrating a method for retrieving, verifying, and displaying an educational accomplishment of a learner in accordance with at least one embodiment. The aspect of the system illustrated in FIG. 8 provides for verification of educational accomplishment of a learner. Method 800 begins in block 801 and continues to block 802. In block 802, the system receives a request for verification of an educational accomplishment of a learner from an outside source (e.g. a potential employer). From block 802, method 800 continues to block 803. In block 803, the system retrieves an entry stored in the immutable storage pertaining to the educational accomplishments of the learner. Method 800 continues from block 803 to block 804. In block 804, the system then retrieves the corresponding educational accomplishment. Method 800 continues from block 804 to block 805. The system then uses the entry stored in the immutable storage to perform the verification in block 805. From block 805, method 800 continues to block 806. If verification passes, the system also checks for revocation of the educational accomplishment in block 806. From block 806, method 800 continues to block 807. The system displays the identity of the learner in block 807. From block 807, method 800 continues to block 808. If the educational accomplishment is verified and not revoked, the verified educational accomplishment of the learner is displayed in block 808.

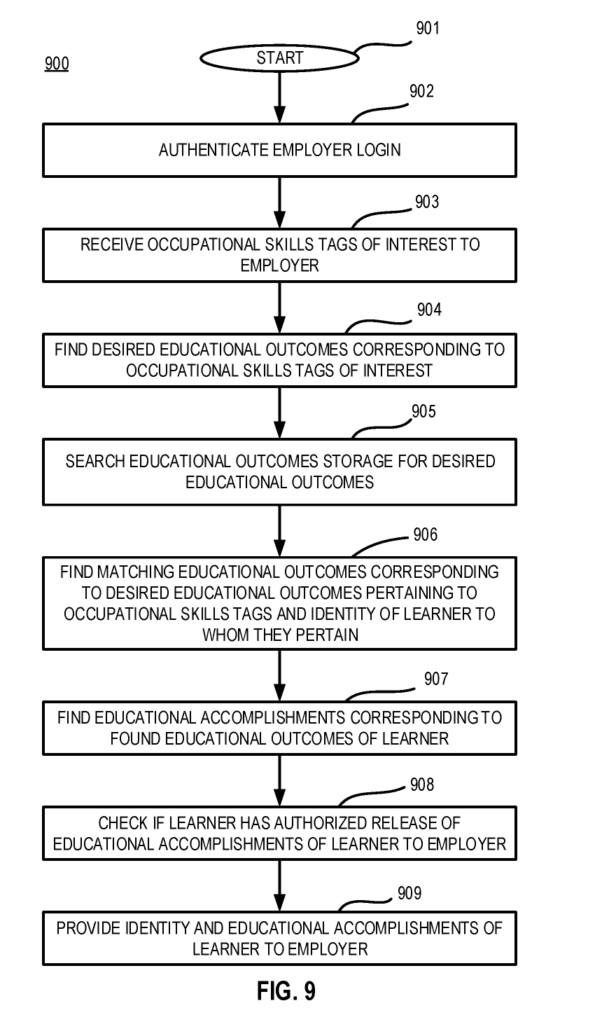

FIG. 9 is a flow diagram illustrating a method for selectively providing an employer with an identity and educational accomplishments of a learner pertaining to occupational skills tags of interest to the employer in accordance with at least one embodiment. Method 900 begins in block 901 and continues to block 902. An employer logs into system and is authenticated in block 902. From block 902, method 900 continues to block 903. The system then receives occupational skills tags that are of interest to the employer in block 903. From block 903, method 900 continues to block 904. In block 904, the system then finds desired educational outcomes corresponding to the occupational skills tags of interest to the employer. Method 900 continues from block 904 to block 905. In block 905, the system then searches the educational outcomes store for the desired educational outcomes. Method 900 continues from block 905 to block 906. In block 906, the system attempts to find matching educational outcomes corresponding to the desired educational outcomes pertaining to the occupational skills tags of interest. From block 906, method 900 continues to block 907. In block 907, the system then finds the identity of the learner to whom they pertain, and the educational accomplishments corresponding to the found educational outcomes of the learner. From block 907, method 900 continues to block 908. In block 908, the system then checks if the learner has authorized release of the educational accomplishments of the learner to the employer. Method 900 continues from block 908 to block 909. If the learner has authorized release of the educational accomplishments of the learner to the employer, as determined in block 908, the system provides the identity and educational accomplishments of the learner to the employer in block 909.

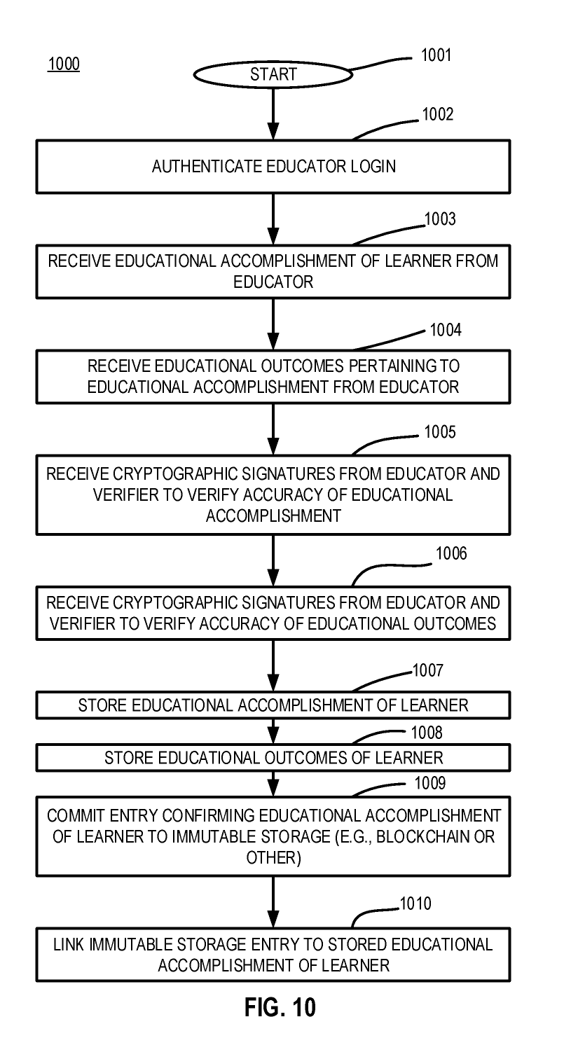

FIG. 10 is a flow diagram illustrating a method for storing an educational accomplishment and an educational outcome of a learner upon cryptographic signature of an educator and a verifier in accordance with at least one embodiment. Method 1000 begins at block 1001 and continues to block 1002. In block 1002, the system authenticates the educator login. From block 1002, method 1000 continues to block 1003. In block 1003, the system received educational accomplishments of the learner from the educator. From block 1003, method 1000 continues to block 1004. In block 1004, the system then retrieves the educational outcomes pertaining to the educational accomplishments from the educator. Method 1000 continues from block 1004 to block 1005. The system further provides security before committing information confirming an educational accomplishment to the immutable storage. The system includes a verifier in the process before the information can be committed to the immutable storage. Accordingly, in block 1005, the system receives cryptographic signatures from both educator and verifier to verify the accuracy of the educational accomplishments received from the educator. From block 1005, method 1000 continues to block 1006. In block 1006, the system receives cryptographic signatures from both educator and verifier to verify the accuracy of the educational outcomes received from the educator. Method 1000 continues from block 1006 to block 1007. Once verification is complete, the system stores the educational accomplishments of the learner in block 1007. Method 1000 continues from block 1007 to block 1008. The system stores the related educational outcomes in block 1008. From block 1008, method 1000 continues to block 1009. The system commits the entry confirming the educational accomplishment of the learner to the immutable storage in block 1009. From block 1009, method 1000 continues to block 1010. The system then links the new immutable storage entry to the stored educational accomplishment of the learner in block 1010.

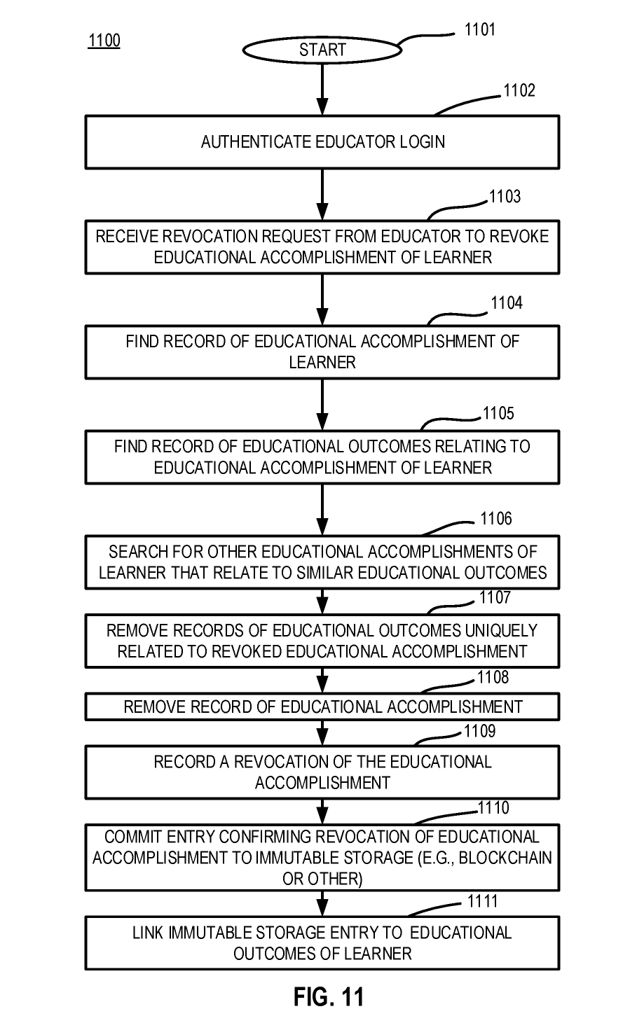

FIG. 11 is a flow diagram illustrating a method for revoking an educational accomplishment of a learner in accordance with at least one embodiment. The aspect of the system illustrated in FIG. 11 provides for revocation of an educational accomplishment of a learner. An entry confirming revocation of the educational accomplishment is committed to the immutable storage. Method 1100 begins in block 1101 and continues to block 1102. In block 1102, an educator logs into the system and is authenticated. From block 1102, method 1100 continues to block 1103. In block 1103, the system receives a revocation request from the educator in order to revoke an educational accomplishment of the learner. This may occur for a variety of reasons, such as an error in committing the educational accomplishment originally, or revocation of the learner's educational achievement by the educational institution. From block 1103, method 1100 continues to block 1104. In block 1104, the system then finds the record of educational accomplishments of the learner. Method 1100 continues from block 1104 to block 1105. In block 1105, the system then finds the record of the related educational outcomes of the learner. From block 1105, method 1100 continues to block 1106. Since the storage of the educational accomplishments and educational outcomes are intentionally immutable, these entries cannot be deleted. Therefore, the system must store information indicating the revocation of these entries. In block 1106, the system finds searches for other educational accomplishments of the learner that relate to similar educational outcomes. From block 1106, method 1100 continues to block 1107. Since an educational outcome may relate to another educational achievement that has not been revoked, only educational outcomes that are specifically related only to the revoked educational achievement are noted as removed in block 1107. From block 1107, method 1100 continues to block 1108. In block 1108, the system then indicates the revoked educational accomplishment for removal. Method 1100 continues from block 1108 to block 1109. In block 1109, the system records the revocation. Method 1100 continues from block 1109 to block 1110. The entry confirming revocation of the educational accomplishment is then committed to the immutable storage in block 1110. From block 1110, method 1100 continues to block 1111. In block 1111, the immutable storage entry indicating that revocation is linked to the learner.

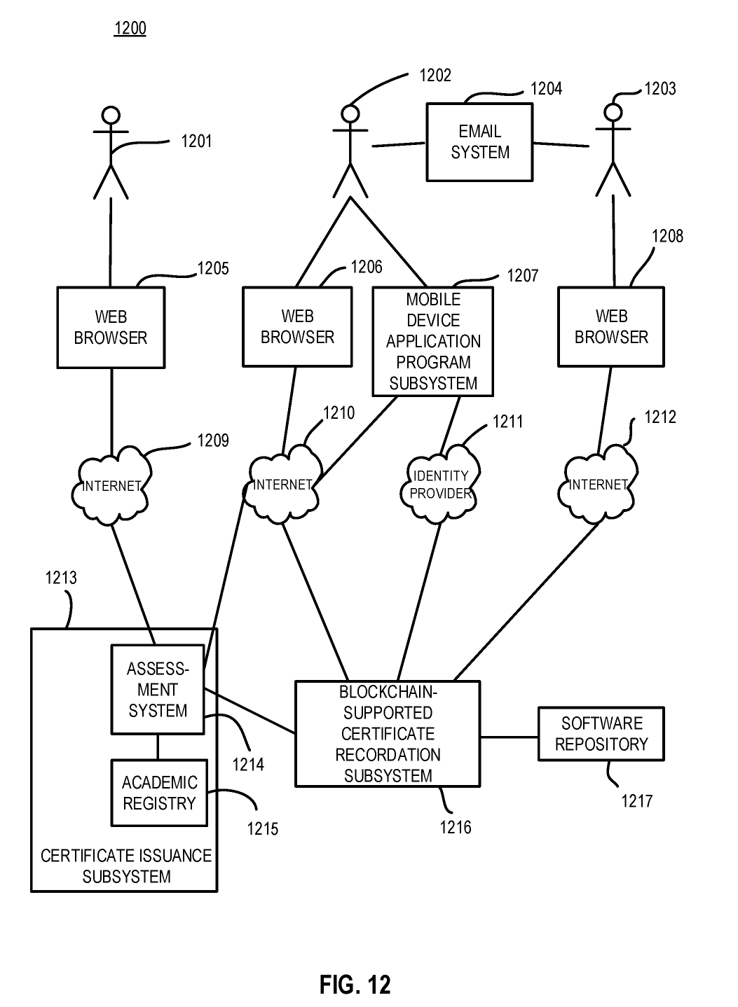

FIG. 12 is a block diagram illustrating an educational supply side subsystem of the system in accordance with at least one embodiment. Educational supply side subsystem 1200 comprises certificate issuance subsystem 1213, blockchain-supported certificate recordation subsystem 1216, and software repository 1217. Certificate issuance subsystem 1213 comprises assessment system 1214 and academic registry 1215. Assessment system 1214 is coupled to academic registry 1215. Assessment system 1214 of certificate issuer subsystem 1213 is coupled to blockchain-supported certificate recordation subsystem 1216. Blockchain-supported certificate recordation subsystem 1216 is coupled to software repository 1217.

Assessment system 1214 of certificate issuer subsystem 1213 is coupled via a network 1209 (e.g., a global data network such as the Internet) to a web browser subsystem 1205 at instructor node 1201. Assessment system 1214 of certificate issuer subsystem 1213 is coupled via a network (e.g., a global data network such as the Internet) to a web browser subsystem 1206 at learner node 1202 and to a mobile device application program subsystem 1207 at learner node 1202. Blockchain-supported certificate recordation subsystem 1216 is coupled via a network (e.g., a global data network such as the Internet) to web browser subsystem 1206 and mobile device application program subsystem 1207. Mobile device application program subsystem 1207 is coupled via an identity provider node 1211 to blockchain-supported certificate recordation subsystem 1216. Identity provider 1211 can authenticate access to the blockchain-supported certificate recordation subsystem 1216 from a learner node 1202 and management an online identity of a learner of learner node 1202. As an example, upon authentication, learner node 1202 can access blockchain-supported certificate recordation subsystem 1216 via web browser subsystem 1206 or mobile device application program subsystem 1207 and network 1210.

Blockchain-supported certificate recordation platform 1216 is coupled via a network 1212 (e.g., a global data network such as the Internet) to a web browser 1208 at a verifier node 1203. Verifier node 1203 is coupled via an email system 1204 to learner node 1202. Verifier node 1203 can communicate with learner node 1202 via email messages sent and received over email system 1204.

As an example shown in FIG. 12, the issuing educational institution includes an assessment system and an academic registry. The assessment system represents a grading system that can interface with the system to register badges and learners and to issue certificates. Instructors can access this system via a data network, for example, the Internet. An instructor evaluates and assigns a grade to a learner's work. If the grade is considered passing, then the learner is awarded a digital certificate via the system. The issuing educational institution also maintains an academic registry reflecting the academic achievements of the learners. The assessment system interacts with the academic registry to allow learners via mobile computing device and internet access to authenticate, log in, and interact with the system. Learners are the students who have completed or are in the process of completing a given academic curriculum, and have achieved digital certificates. Learners can demonstrate achievements by emailing certificate uniform resource locators (URLs) to interested parties. Verifiers can view and validate certificates through the system. Learners can create collections of verified achievements that can be published to employers. Further, a customer relationship management system is provided to serve as the identity provider for learners and administration.

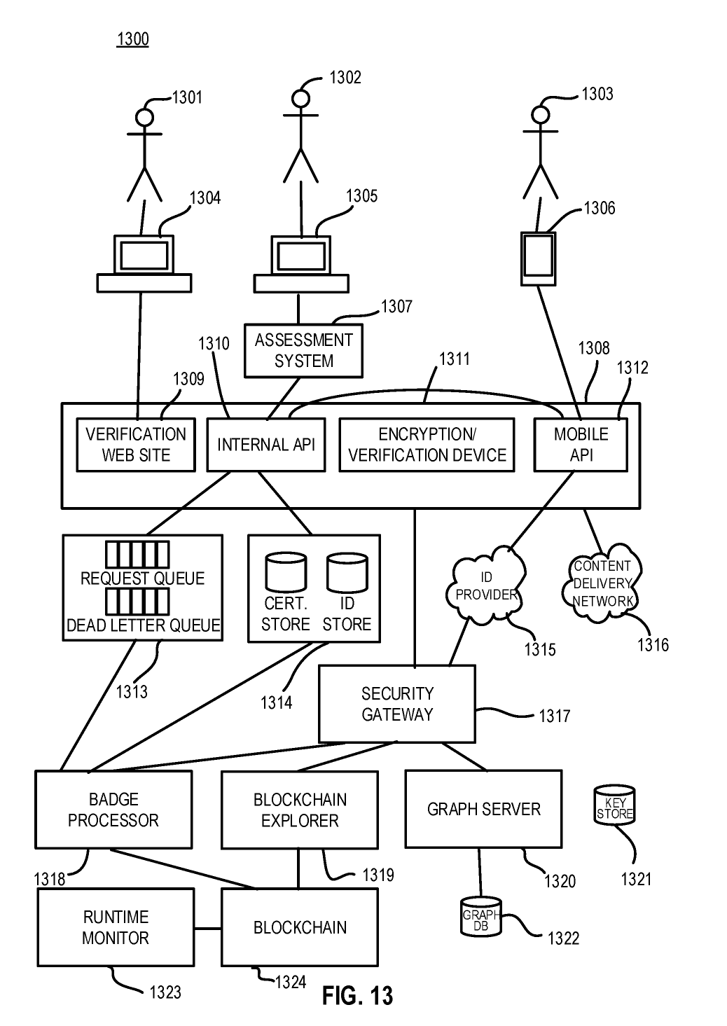

FIG. 13 is a block diagram illustrating the functional architecture of the system in accordance with at least one embodiment. System 1300 comprises a front-end subsystem 1308, a queue subsystem 1313, a storage subsystem 1314, a security gateway 1317, a badge processor 1318, a blockchain explorer 1319, a runtime monitor 1323, a blockchain immutable store 1324, a graph server 1320, a graph database 1322, and a key store 1321. Front-end subsystem 1308 comprises verification web site subsystem 1309, internal application programming interface (API) subsystem 1310, encryption and verification device 1311, and mobile API subsystem 1312. A verifier node 1301 can access verification web site interface 1309 via a web browser subsystem on a client device 1304. Client device 1304 is coupled to verification web site subsystem 1309 of front-end subsystem 1308. An educator node 1302 can a client device 1305 at educator node 1302 to access an assessment system 1307 and, via assessment system 1307, front-end subsystem 1308. Client device 1305 is coupled to assessment system 1307. Assessment system 1307 is coupled to internal API subsystem 1310 of front-end subsystem 1308. Educator node 1302 can use internal API subsystem 1310 to submit requests to queue subsystem 1313 and certificates and identities to storage subsystem 1314.

A learner node 1303 can use a client device 1306, for example, a mobile device, to access mobile API subsystem 1312 of front-end subsystem 1308. Client device 1306 is coupled to mobile API subsystem 1312. Mobile API subsystem 1312 is coupled to identity provider subsystem 1315. Identity provider subsystem 1315 is coupled to security gateway 1317. Front-end subsystem 1308 is coupled to security gateway 1317. Front-end subsystem 1308 is coupled to content delivery network (CDN) 1316. CDN 1316 can provide data content to client device 1306 at learner node 1303 via mobile API subsystem 1312. Upon authentication by identity provider 1315, learner node 1303 can access, via security gateway 1317, elements such as blockchain explorer 1319, which can verify certificates earned by the learner node 1303, as may be stored in the certificate store of storage subsystem 1314, using verification information stored in blockchain immutable storage 1324 pertaining, at least in part, to the certificate.

Requests by an educator node 1302 can be verified by a verifier node 1301, which can access front-end subsystem 1308 via verification web site subsystem 1309. Educator node 1302 can submit requests via internal API subsystem 1310 to queuing subsystem 1313. Examples of requests include requests for a badge to be associated with or disassociated from a learner identity. As an example, valid requests can be stored in the request queue of queuing subsystem 1313. Invalid requests, such as requests that cannot be associated with a valid learner identity, can be stored in the dead letter queue of queuing subsystem 1313.

Badge processor 1318 can process requests from the request queue of queuing subsystem 1313. Badge processor 1318 can access the certificate store and the identity store of storage subsystem 1314. Badge processor 1318 can generate verification information pertaining to one or more certificates in the certificate store of storage subsystem 1314 and can commit the verification information to immutable storage, such as blockchain immutable storage 1324.

Graph server 1320 can be used by a node, such as verifier node 1301, educator node 1302, or learner node 1303, to obtain information from graph database 1322. The information from graph database 1322 can be used to provide metrics as to the operation of system 1300. For example, the metrics can be used for management of system 1300. Key store 1321 can be used to securely store cryptographic keys used to secure information stored in and processed by other components of system 1300.

Verification subsystem 1309 can be implemented, for example, as a verification website and a verification service. For example, learners are awarded certificates when they meet the completion criteria of an academic program. Learners are able to share their accomplishment with whomever they please. The person with whom the learner shares a badge needs a way to view the certificate and verify its authenticity. The verification web site allows the user to verify a specified certificate against an immutable store, such as blockchain immutable store 1324. This service interacts with the blockchain via the blockchain remote procedure call (RPC) application programming interface (API) through the security gateway. It also provides a centralization of encryption capabilities for the other resources and it provides the ability to generate cryptographic keys, such as Rivest-Shamir-Adelman (RSA) keys, for the internal API.

Internal API subsystem 1310 allows interaction with other components of system 1300. At least one embodiment of the disclosed subject matter includes an API to interface with the various system components. For example, the API allows registration of certificate issuing institutions; registration of learners, awarding of a digital certificate to a learner; awarding a batch of digital certificates to many learners; and revoking a certificate from a learner.

The request queue of queuing subsystem 1313 can provide guaranteed delivery of requests, such as requests relating to badges (e.g., educational outcomes) and certificates on a dedicated request queue.

The dead letter queue of queuing subsystem 1313 provides a mechanism for handling invalid requests. For example, when a request to award or revoke a certificate cannot be processed, it is stored on a dedicated dead letter queue.

A certificate receipt store can be implemented. The certificate receipt store is responsible for storing a digitally signed “receipt” of a certificate that has been awarded. It is used in conjunction with immutable storage, such as blockchain immutable store 1324, to prove that a certificate is valid.

The identity store of storage subsystem 1314 can be used to store identity information pertaining to the identities of learners using system 1300. At least one embodiment can utilize a full identity provider such as an externally provided full identity provider service. Alternatively, a simplified identity store can be used to provide a mechanism to store identity information related to learners and certificate issuing institutions.

A certificate processing application can be implemented within system 1300. Awarding and revoking certificates can be handled by a headless application (an application without a graphic user interface for itself) that consumes requests from the inbound request queue and interfaces directly with the immutable store, such as blockchain immutable store 1324. Requests that cannot be fulfilled are placed on the dead letter queue. Certificate receipts of awarded certificates are stored in the certificate receipt store. Additionally, the application interfaces with the graph service to update the property graph of the creation of revocation of certificates.

A blockchain (e.g., multichain) explorer 1319 is provided and can be used for viewing the contents of an immutable store, such as blockchain immutable store 1324. The blockchain infrastructure can be structured such that the blockchain components are physically separated. Blockchain components can be under the control of different owners. Blockchain components can provide redundancy so that verification information stored in blockchain immutable store 1324 can survive a failure of a portion of the blockchain components. There can be a dedicated explorer for accomplishments and revocations separately.

Graph server 1320 can help organize system 1300. At least one embodiment utilizes a property graph to maintain the relationships between issuers, learners, badges, certificates, and certificate collections (e.g., stacks in the mobile app).

Key Store 1321 can provide storage of cryptographic key information to facilitate management of the keys and secure access to system 1300. One of the major challenges of adopting a blockchain based system is the management of cryptographic keys. Each actor in the system can have a dedicated public/private key pair.

At least one embodiment utilizes a run time monitor to enable monitoring, metrics collections, and log aggregation. A stand-alone dashboard can be provisioned to view the system capabilities in real time.

Immutable storage provides reliability in accurate storage of information, such as certificates earned by learners. The system utilizes it as the system of record for awarded and revoked certificates. In accordance with at least one embodiment, immutable storage is implemented across five groups of servers. The first group includes the system administrator servers: The administrators are referred to as the “master” servers and are responsible for storing a full copy of all chains for backup and restore. They are the first servers with which a new node connects. They provide new members the list of all the members and provide a copy of all the chains. In this sense, they are a “seeder.” As administrators, they are the only servers that can allow new members into the peer group. The second group includes the accomplishment chain. The second group of servers is dedicated to hosting the accomplishment chain and mining new blocks. The third group of servers includes the revocation chain. The third group of servers is dedicated to hosting the revocation chain and mining new blocks. The fourth group of servers includes the accomplishment explorer. The accomplishment explorer is responsible for hosting a copy of the accomplishment chain and a dedicated explorer web application and index database. The fifth group of servers includes the revocation explorer. The fifth group of servers is responsible for hosting a copy of the revocation chain and a dedicated explorer web application and index database. Other configurations may be implemented in accordance with other embodiments.

A graph database is provided to store information relating to a property graph. At least one embodiment utilizes a property graph to manage relationships. The relationships can include relationships between instructors, educators, verifiers, learners, and employers. The relationships can include relationships between learner identities, educational outcomes (e.g., badges), certificates, and skills tags.

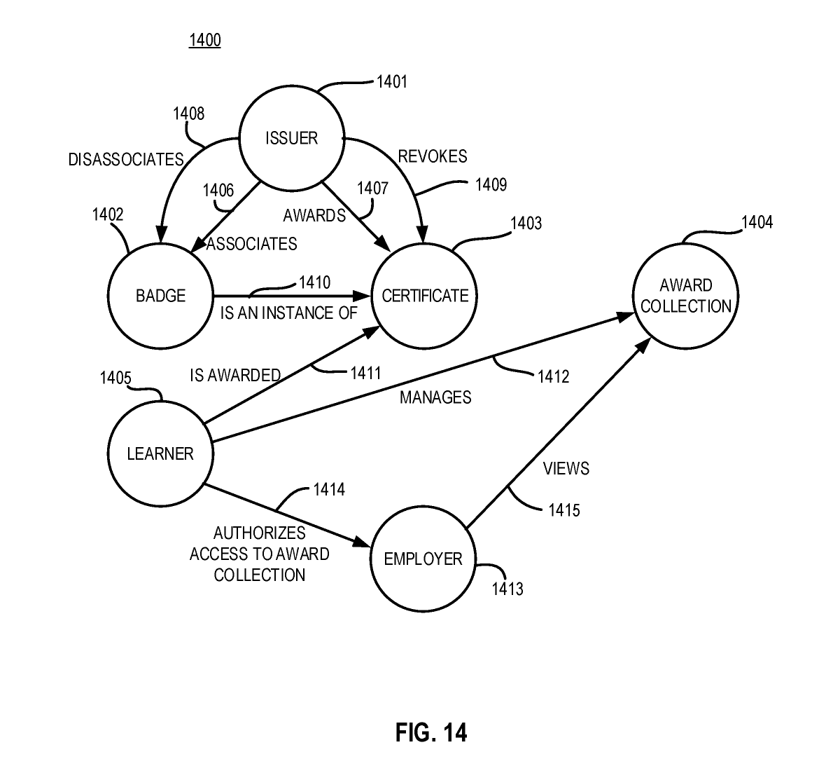

FIG. 14 is a block diagram illustrating the graph service architecture of the system in accordance with at least one embodiment. Institutions that can issue or revoke digital certificates are represented by issuer vertices. Certificates are instances of badges that have been registered with an issuing institution. Once a certificate has been issued to a learner, the learner may manage collections of the certificates. The data model can be seen below. Vertices are represented by circles. Their properties are displayed as associated rounded boxes. Edges are represented as directional lines and curves.

System 1400 comprises an issuer 1401, a badge 1402, a certificate 1403, a learner 1405, an employer 1413, and an award collection 1404. Issuer 1401 can associate badge 1402 with learner 1405 via path 1406. Issuer 1401 can disassociate badge 1402 from learner 1405 via path 1408. Issuer 1401 can award a certificate 1403 to learner 1405 via path 1407. Issuer 1401 can revoke a certificate 1403 previously issued to learner 1405 via path 1409. A badge 1410 can, for example, be an instance of or an element of certificate 1043, as depicted by relationship 1410.

Learner 1405 can earn and be awarded a certificate 1403, as depicted by relationship 1411. Learner 1405 can manage an award collection 1404. Award collection 1404 may, for example, be a collection of information descriptive of certificates, such as certificate 1403, that learner 1405 has been awarded. Learner 1405 can authorize access to an award collection. As an example depicted by relationship 1414, learner 1405 can authorize an employer 1413 access to an award collection of awards (e.g., certificates 1403) learner 1405 has received. Employer 1413 can view the award collection 1404, as illustrated by relationship 1415.

A user has an associated profile. Learners are assigned a learner profile. The learner profile is then granted access to a connected app that the mobile application leverages and associated custom permissions. The custom permissions are mapped to API calls on the security gateway. By combining the user's profile to a connected app and then custom permissions, the system is able to generate JavaScript object notation (JSON) web tokens (JWT's) on the user's behalf when the mobile application requires access to an external API. Examples of custom permissions that may be provided are custom permissions to update the learner profile, to create a badge, to associate a badge with a learner, to disassociate a badge from a learner, to read a badge, to award a certificate, to revoke a certificate, to read a certificate, to verify a certificate, to create a certificate collection, to read a certificate collection, and to verify a certificate collection.

In accordance with at least one embodiment, a key store is provided to store cryptographic key information. Accordingly, access to the system can be cryptographically authenticated using cryptographic keys. Blockchain may be leveraged as immutable storage to provide the IT capability of storing student's accomplishments. Accomplishments could be stored in several different ways. Traditional databases or distributed filesystems can provide storage and access. As an advantage of blockchain over traditional solution, blockchain can, in addition to basic storage, provide a layer of trust that the data stored on blockchain was created by the group that claims creation, and prevent the data from being tampered with.

In accordance with at least one embodiment, various graph store components can be integrated into the system. A blockchain has the ability to store distributed immutable data. This is ideal for implementing a shared digital ledger. It is less than ideal, by itself, for defining changing relationships between domain objects and people. User-generated data are stored such that they can change frequently. Additionally, a history of user experiences and relationships between users and their accomplishments can be captured and stored.

In accordance with at least one embodiment, a property graph data model can be used to define a physical architecture of an embodiment of the system. A property graph data model can provide a storage mechanism for the uses cases that are a poor fit for a blockchain by itself. A graph structure can be advantageous over a traditional relational database due to a graph's ability to rapidly evolve the schema, an emphasis on data relationships, and the potential for performing cause-and-effect analysis.

In accordance with at least one embodiment, a system may be implemented according to a distributed system architecture. For example, a micro-service architecture may be distributed over two cloud platforms. The size of the platform can change based on how much load it should be configured to handle. In accordance with at least one embodiment, commercially available cloud platforms can be used to host the runtime of the platform. In accordance with at least one embodiment, a commercially available identity provider may be used as an identity provider and for providing administration capabilities.

In accordance with at least one embodiment, the platform can be deployed as a distributed system while still implemented with a low level of redundancy. In accordance with at least one embodiment, an availability zone implementation can make the platform be available over multiple zones in multiple regions. Even if any one region or zone experiences an outage, the platform will continue undisrupted operation.

From the perspective of servers and clusters, the system is architected to be redundant. Servers may be performing multiple functions, or may be restricted to just one to increase fault tolerance. Tasks may be distributed to capability focused clusters. All functions can be performed concurrently and the majority of assets are deployed in a scalable configuration. The majority of components are deployed to a scalable cluster fronted by a load balancer.

In accordance with at least one embodiment, a system can comprise an immutable store (e.g., blockchain immutable store) administration component, an accomplishment explorer component, an immutable store (e.g., blockchain immutable store) explorer component, a workers component, a badge processor component, a security gateway component, a graph service component, a monitoring component, a content delivery network (CDN) server component, a database seeders component, a database workers component, a service discovery and flag value store component, and a vault component. Such components can be implemented using elements such as those described herein, for example, with respect to FIGS. 1, 3, 12, 13, and 15.

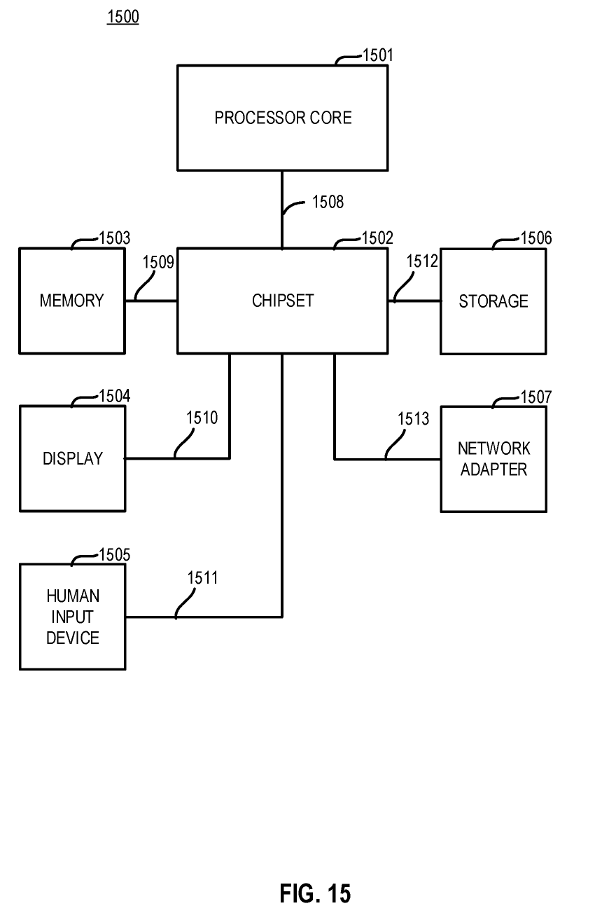

FIG. 15 is a block diagram of an information processing system that may be used to implement a system or method or one or more elements thereof in accordance with at least one embodiment. Information processing system 1500 comprises processor core 1501, chipset 1502, memory 1503, display 1504, human input device 1505, storage 1506, and network adapter 1507. Multiple instances of such elements may be implemented. As an example, one instance of network adapter 1507 may be implemented as a wired network adapter, and another instance of network adapter 1507 may be implemented as a wireless network adapter. Processor core 1501 is connected to chipset 1502 via interconnect 1508. Chipset 1502 is connected to memory 1503 via interconnect 1509. Chipset 1502 is connected to display 1504 via interconnect 1510. Chipset 1503 is connected to human input device 1505 via interconnect 1511. Chipset 1502 is connected to storage 1506 via interconnect 1512. Chipset 1502 is connected to network adapter 1507 via interconnect 1513.

The elements depicted in FIG. 15 may comprise multiple types of those elements, which may be implemented in one or more instances of the respective elements. As an example, memory 1503 may comprise volatile memory, nonvolatile memory, or a combination thereof. Display 1504 may comprise a video display, a liquid crystal display (LCD), a light emitting diode (LED) display, the like, or combinations thereof. Human interface device 1505 may comprise a touch screen, a keyboard, a mouse, a trackpad, a pointer stick, a track ball, a joystick, the like, or combinations thereof. Storage 1506 may comprise a hard disk drive (HDD), a solid state drive (SSD), a flash memory card, the like, or combinations thereof. Network adapter 1507 may comprise an ethernet adapter, a wifi adapter, a Bluetooth adapter, a personal area network (PAN) adapter, the like, or combinations thereof.

In accordance with at least one embodiment, the system can be implemented using multiple automation layers. To improve performance over that of a single automation layer being responsible for the entire runtime, the upper automation layer can be split into multiple atomic stacks. In this exemplary embodiment, five atomic stacks were used. Each new stack is responsible for the provisioning of one or more blockchain capabilities. As new capabilities are added to the overall infrastructure, they can be included in the automation layer by way of an isolated stack. Additionally, a new cross-cutting layer can be added to isolate one or more functions, such as domain name service (DNS) provisioning.

In accordance with at least one embodiment, a method comprises recording to an academic record issuance database a first certificate representing a first educational accomplishment of a learner, recording a first set of educational outcomes attained pertaining to the first educational accomplishment, committing to an academic record issuance immutable store an issuance verification value dependent on the first certificate, recording a first set of occupational skills tags pertaining to the first set of educational outcomes, then, for a second badge representing a second educational accomplishment not yet attained by the learner, determining a potential effectuality index (PEI) value based on a second set of educational outcomes pertaining to the second educational accomplishment and on a second set of occupational skills tags pertaining to the second set of educational outcomes, and generating a guidance plan for the learner based on the PEI.

In accordance with at least one embodiment, the PEI is based on a squared quotient of a first number of occupational skills tags elements of the second set of occupational skills tags divided by a second number of educational outcome elements of the second set of educational outcomes. In accordance with at least one embodiment, the PEI is further based on an average social credibility rating from one or more learner nodes pertaining to the second badge. In accordance with at least one embodiment, the PEI is further based on a third number of favorite ratings from one or more employer nodes pertaining to the second badge. In accordance with at least one embodiment, the PEI is based on a product of the average social credibility rating times the third number of favorite ratings times the squared quotient.

In accordance with at least one embodiment, the method further comprises recording a first badge representing a first educational accomplishment of a learner, recording a first set of educational outcomes attained pertaining to the first educational accomplishment, recording a first set of occupational skills tags pertaining to the first set of educational outcomes, receiving a first set of occupational skills tags from an employer node, mapping a first subset of the first set of occupational skills tags to a third set of educational outcomes, identifying an unmapped occupational skills tag among the first set of occupational skills tags, identifying an educational outcome closely related to the unmapped occupational skills tag, identifying an educational accomplishment associated with the educational outcome closely related to the unmapped occupational skills tag, and modifying a curriculum of the educational accomplishment to include a new educational outcome that maps to the unmapped occupational skills tag to produce a new curriculum of the educational accomplishment.

In accordance with at least one embodiment, the method further comprises recording to an academic record revocation database a first certificate revocation representing revocation of the first certificate and committing to an academic record revocation immutable store a revocation verification value dependent on the first certificate revocation. In accordance with at least one embodiment, the method further comprises, prior to committing the revocation verification value to the academic record revocation immutable store, performing a verification of the first certificate using the issuance verification value committed to the academic record issuance immutable store.

In accordance with at least one embodiment, a system for recording educational accomplishments and for managing records pertaining thereto is provided. The system comprises an educational outcomes database configured to store educational outcomes achieved by learners, an academic record database configured to store certificates earned by learners, an occupational skills tags database configured to store occupational skills tags, an academic record immutable store configured to store a verification value dependent on at least a first one of the certificates, and a processor, the processor coupled to the educational outcomes database, to the academic record database, and to the occupational skills tags database, the processor comprising a learner node interface, an educator node interface, and an employer node interface, the processor configured to interface to at least one learner node via the learner node interface, to at least one educator node via the educator node interface, and to at least one employer node via the employer node interface, the processor further configured to process requests to access the educational outcomes database, the academic record database, and the occupational skills tags database.

In accordance with at least one embodiment, the academic record database comprises an academic record issuance database and an academic record revocation database, wherein the academic record immutable store comprises an academic record issuance immutable store and an academic record revocation immutable store. In accordance with at least one embodiment, the system further comprises a pre-revocation academic record verification interlock, the pre-revocation academic record verification interlock coupled to the academic record issuance database, to the academic record revocation database, and to the academic record issuance immutable store, the pre-revocation academic record verification interlock configured to verify a certificate stored in the academic record issuance database using a verification value pertaining to the certificate and stored in the academic record issuance immutable store before storing a certificate revocation in the academic record revocation database to revoke the certificate. In accordance with at least one embodiment, the system further comprises a course designing processor coupled to the educational outcomes database, to the academic record database, and to the occupational skills tags database, the course designing processor configured to identify an unmapped occupational skills tag, to identify an educational outcome closely related to the unmapped occupational skills tag, to identify an educational accomplishment associated with the educational outcome closely related to the unmapped occupational skills tag, and to modify a curriculum of the educational accomplishment to include a new educational outcome that maps to the unmapped occupational skills tag to produce a new curriculum of the educational accomplishment. In accordance with at least one embodiment, the processor is configured to select a learner identity from among a plurality of learner identities, to retrieve a set of educational outcome elements pertaining to the learner identity from a database of educational outcome elements, to verify the set of educational outcome elements pertaining to the learner identity according to a verification value stored in the academic record immutable store, and to perform a weighted matching of occupational skills tags to the set of educational outcome elements to produce a set of associations of the set of educational outcome elements with each of a plurality of the occupational skills tags. In accordance with at least one embodiment, the processor is configured to determine a potential effectuality index (PEI) value based on a second set of educational outcomes pertaining to the second educational accomplishment and on a second set of occupational skills tags pertaining to the second set of educational outcomes and to generate a guidance plan for the learner based on the PEI. In accordance with at least one embodiment, the processor is configured to receive from an employer node a set of occupational skills tags of interest to an employer, to find desired educational outcomes corresponding to the set of occupational skills tags of interest, to search the educational outcomes database for the desired educational outcomes, to find matching educational outcomes corresponding to the desired educational outcomes and to identify a learner to whom the matching educational outcomes pertain, to find educational accomplishments of the learner, to check whether the learner has authorized release of the educational accomplishments to the employer, and to provide the educational accomplishments and an identity of the learner to the employer node.

In accordance with at least one embodiment, a method comprises receiving an educational outcome achieved by a learner, recording to an educational outcome database the educational outcome, receiving an educational accomplishment completed by the learner, recording to an academic record database the educational accomplishment, receiving an occupational skills tag, recording to an occupational skills tag database the occupational skills tag, determining a potential effectuality index (PEI) value based on a set of educational outcomes pertaining to a second educational accomplishment and a set of occupational skills tags pertaining to the set of educational outcomes, and generating a guidance plan for the learner based on the PEI. In accordance with at least one embodiment, the method further comprises committing to an academic record immutable store a verification value for verifying the educational accomplishment recorded to the academic record database. In accordance with at least one embodiment, the recording to the academic record database of the educational accomplishment comprises recording to an academic record issuance database the educational accomplishment, wherein the committing to the academic record immutable store comprises committing to an academic record issuance immutable store the verification value, wherein the method further comprises recording to an academic record revocation database a revocation of the educational accomplishment and committing to an academic record revocation immutable store a revocation verification value for verifying revocation of the educational accomplishment. In accordance with at least one embodiment, the method further comprises reading the educational accomplishment from the academic record issuance database, reading the verification value from the academic record issuance immutable store, and verifying the educational accomplishment using the verification value before performing the recording of the revocation of the educational accomplishment to the academic record revocation database and committing the revocation verification value to the academic record revocation immutable store. In accordance with at least one embodiment, the PEI is based on a squared quotient of a first number of occupational skills tags elements of the second set of occupational skills tags divided by a second number of educational outcome elements of the second set of educational outcomes.

In accordance with at least one embodiment, a method comprises selecting a learner identity from among a plurality of learner identities, retrieving a set of educational outcome elements pertaining to the learner identity from a database of educational outcome elements, verifying the set of educational outcome elements pertaining to the learner identity according to an academic record immutable store, and performing a weighted matching of occupational skill tags to the set of educational outcome elements to produce a set of associations of the set of educational outcome elements with each of a plurality of the occupational skill tags.

The concepts of the present disclosure have been described above with reference to specific embodiments. However, one of ordinary skill in the art will appreciate that various modifications and changes can be made without departing from the scope of the present disclosure as set forth in the claims below. In particular, the system and method may be implemented over a broad range of scales to support any number of instructors, educators, verifiers, learners, employers, other entities, subsets thereof, and the like. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
recording to an academic record issuance database a first certificate representing a first educational accomplishment of a learner;
recording a first set of educational outcomes attained pertaining to the first educational accomplishment;
committing to an academic record issuance immutable store an issuance verification value dependent on the first certificate;
recording a first set of occupational skills tags pertaining to the first set of educational outcomes;
for a second badge representing a second educational accomplishment not yet attained by the learner, determining a potential effectuality index (PEI) value based on a second set of educational outcomes pertaining to the second educational accomplishment and on a second set of occupational skills tags pertaining to the second set of educational outcomes;
generating a guidance plan for the learner based on the PEI.

2. The method of claim 1 wherein the PEI is based on a squared quotient of a first number of occupational skills tags elements of the second set of occupational skills tags divided by a second number of educational outcome elements of the second set of educational outcomes.

3. The method of claim 2 wherein the PEI is further based on an average social credibility rating from one or more learner nodes pertaining to the second badge.

4. The method of claim 3 wherein the PEI is further based on a third number of favorite ratings from one or more employer nodes pertaining to the second badge.

5. The method of claim 4 wherein the PEI is based on a product of the average social credibility rating times the third number of favorite ratings times the squared quotient.

6. The method of claim 1 further comprising:
recording first badge representing a first educational accomplishment of a learner;
recording a first set of educational outcomes attained pertaining to the first educational accomplishment;
recording a first set of occupational skills tags pertaining to the first set of educational outcomes;
receiving a first set of occupational skills tags from an employer node;
mapping a first subset of the first set of occupational skills tags to a third set of educational outcomes;
identifying an unmapped occupational skills tag among the first set of occupational skills tags;
identifying an educational outcome closely related to the unmapped occupational skills tag;
identifying an educational accomplishment associated with the educational outcome closely related to the unmapped occupational skills tag;
modifying a curriculum of the educational accomplishment to include a new educational outcome that maps to the unmapped occupational skills tag to produce a new curriculum of the educational accomplishment.

7. The method of claim 1 further comprising:
recording to an academic record revocation database a first certificate revocation representing revocation of the first certificate;
committing to an academic record revocation immutable store a revocation verification value dependent on the first certificate revocation;

8. The method of claim 7 further comprising:
prior to committing the revocation verification value to the academic record revocation immutable store, performing a verification of the first certificate using the issuance verification value committed to the academic record issuance immutable store.

9. A system for recording educational accomplishments and for managing records pertaining thereto, the system comprising:
an educational outcomes database configured to store educational outcomes achieved by learners;
an academic record database configured to store certificates earned by learners;
an occupational skills tags database configured to store occupational skills tags;
an academic record immutable store configured to store a verification value dependent on at least a first one of the certificates; and
a processor, the processor coupled to the educational outcomes database, to the academic record database, and to the occupational skills tags database, the processor comprising a learner node interface, an educator node interface, and an employer node interface, the processor configured to interface to at least one learner node via the learner node interface, to at least one educator node via the educator node interface, and to at least one employer node via the employer node interface, the processor further configured to process requests to access the educational outcomes database, the academic record database, and the occupational skills tags database.

10. The system of claim 9 wherein the academic record database comprises:
an academic record issuance database; and
an academic record revocation database, wherein the academic record immutable store comprises:
an academic record issuance immutable store; and
an academic record revocation immutable store.

11. The system of claim 10 further comprising:
a pre-revocation academic record verification interlock, the pre-revocation academic record verification interlock coupled to the academic record issuance database, to the academic record revocation database, and to the academic record issuance immutable store, the pre-revocation academic record verification interlock configured to verify a certificate stored in the academic record issuance database using a verification value pertaining to the certificate and stored in the academic record issuance immutable store before storing a certificate revocation in the academic record revocation database to revoke the certificate.

12. The system of claim 9 further comprising:
a course designing processor coupled to the educational outcomes database, to the academic record database, and to the occupational skills tags database, the course designing processor configured to identify an unmapped occupational skills tag, to identify an educational outcome closely related to the unmapped occupational skills tag, to identify an educational accomplishment associated with the educational outcome closely related to the unmapped occupational skills tag, and to modify a curriculum of the educational accomplishment to include a new educational outcome that maps to the unmapped occupational skills tag to produce a new curriculum of the educational accomplishment.

13. The system of claim 9 wherein the processor is configured to select a learner identity from among a plurality of learner identities, to retrieve a set of educational outcome elements pertaining to the learner identity from a database of educational outcome elements, to verify the set of educational outcome elements pertaining to the learner identity according to a verification value stored in the academic record immutable store, and to perform a weighted matching of occupational skills tags to the set of educational outcome elements to produce a set of associations of the set of educational outcome elements with each of a plurality of the occupational skills tags.

14. The system of claim 9 wherein the processor is configured to determine a potential effectuality index (PEI) value based on a second set of educational outcomes pertaining to the second educational accomplishment and on a second set of occupational skills tags pertaining to the second set of educational outcomes and to generate a guidance plan for the learner based on the PEI.

15. The system of claim 9 wherein the processor is configured to receive from an employer node a set of occupational skills tags of interest to an employer, to find desired educational outcomes corresponding to the set of occupational skills tags of interest, to search the educational outcomes database for the desired educational outcomes, to find matching educational outcomes corresponding to the desired educational outcomes and to identify a learner to whom the matching educational outcomes pertain, to find educational accomplishments of the learner, to check whether the learner has authorized release of the educational accomplishments to the employer, and to provide a transcript of the educational accomplishments and an identity of the learner to the employer node.

16. A method comprising:
receiving an educational outcome achieved by a learner;
recording to an educational outcome database the educational outcome;
receiving an educational accomplishment completed by the learner;
recording to an academic record database the educational accomplishment;
receiving an occupational skills tag;
recording to an occupational skills tag database the occupational skills tag;
determining a potential effectuality index (PEI) value based on a set of educational outcomes pertaining to a second educational accomplishment and a set of occupational skills tags pertaining to the set of educational outcomes; and
generating a guidance plan for the learner based on the PEI.

17. The method of claim 16 further comprising:
committing to an academic record immutable store a verification value for verifying the educational accomplishment recorded to the academic record database.

18. The method of claim 17 wherein the recording to the academic record database the educational accomplishment comprises:
recording to an academic record issuance database the educational accomplishment, wherein the committing to the academic record immutable store comprises:
committing to an academic record issuance immutable store the verification value, wherein the method further comprises:
recording to an academic record revocation database a revocation of the educational accomplishment; and
committing to an academic record revocation immutable store a revocation verification value for verifying revocation of the educational accomplishment.

19. The method of claim 18 further comprising:
reading the educational accomplishment from the academic record issuance database, reading the verification value from the academic record issuance immutable store, and verifying the educational accomplishment using the verification value before performing the recording the revocation of the educational accomplishment to the academic record revocation database and committing the revocation verification value to the academic record revocation immutable store.

20. The method of claim 16 wherein the PEI is based on a squared quotient of a first number of occupational skills tags elements of the second set of occupational skills tags divided by a second number of educational outcome elements of the second set of educational outcomes.
